(19) United States
(12) Patent Application Publication
(10) Pub. No.: US 2022/0269745 A1
(43) Pub. Date: Aug. 25, 2022

(54) System and Methods for Scrubbing Social Media Content

(71) Applicant: LIFEBRAND LLC, West Chester, PA (US)

(72) Inventors: Thomas J. Colaiezzi, West Chester, PA (US); Jemma Barbarise, West Chester, PA (US); Jan Urban, Prague (CZ); David Reinberger, Prague (CZ); Ugur Oruc, Prague (CZ); Veronika Madzinova, Prague (CZ); James Fiala, Guelph (CA)

(21) Appl. No.: 17/680,188

(22) Filed: Feb. 24, 2022

Related U.S. Application Data
(60) Provisional application No. 63/152,889, filed on Feb. 24, 2021.
(60) Provisional application No. 63/152,902, filed on Feb. 24, 2021.
(60) Provisional application No. 63/152,904, filed on Feb. 24, 2021.

(51) Int. Cl. G06F 16/9535; G06N 20/10; G06N 5/00; G06Q 50/00

(52) U.S. Cl. CPC G06F 16/9535; G06N 20/10; G06N 5/003; G06Q 50/01

(57) ABSTRACT

The disclosed embodiments provide a system for collecting and analyzing data on individual social media for the purpose of detecting and deleting harmful posts. In certain embodiments, the system relies on application programmable interfaces to fetch user posts and local servers to perform profanity and toxicity checks on aforementioned user posts.

### CROSS-REFERENCE TO RELATED APPLICATIONS

This application claims the benefit of U.S. Prov. App. Nos. 63/152,889, 63/152,902, and 63/152,904, each of which is hereby incorporated in its entirety by reference.

### FIELD OF THE INVENTION

The present invention relates to methods, apparatus, and systems, including computer programs encoded on a computer storage medium, for collecting and analyzing social media posts across multiple social media platforms to address possible harmful posts and how it is presented to the client who may choose to delete, ignore or view/modify the post.

### BACKGROUND OF THE INVENTION

Artificial intelligence (AI) is the name of a field of research and techniques in which the goal is to create intelligent systems. Machine learning (ML) is an approach to achieve this goal. Deep learning (DL) is the set of latest most advanced techniques in ML.

The execution of machine learning models and artificial intelligence applications can be very resource intensive as large amounts of processing and storage resources can be consumed. The execution of such models and applications can be resource intensive, in part, because of the large amount of data that is fed into such machine learning models and artificial intelligence applications.

Current tools used in social media involve word-matching, which looks for the occurrence of the query words in social media posts. This type of search is not efficient because the presence or absence of words of the query compared to the quantity of social media does not necessarily confirm the relevance or irrelevance of the found documents. For example, a word search might find documents that contain words but that are contextually irrelevant. Or, if the user applied a different terminology for the query that is contextually or even texturally different than the one in the documents, the word-matching process would fail to match and locate relevant text.

Current word and image analysis are limited in their capabilities. For example, with word-matching research tools, it is crucial to create a word limit in the query presented to the system. Furthermore, all of the words should be in without extraneous detail. However, if the input includes too many generic words, the research tool will return irrelevant social media posts that contain these generic words. This task of choosing very few, but informative words, is challenging, and the user needs prior knowledge of the field to complete the task. The user should know what information is significant or insignificant and therefore, should or should not be included in the search (i.e., contextualization), and further, the proper/accepted terminology that is best for expressing the information (i.e., lexicographical textualization). If the user fails to include the important or correct terms or includes too many irrelevant details, the searching system will not operate successfully.

Even improved analytic tools face the same challenge that word-matching research tools suffer, specifically overfilling, which is a technical term in data science related to when the observer reads too much into limited observations. The improved tools consider and search each record one at a time, independent from the rest of the records, trying to determine whether the social media contains the query or not, without paying attention to the entirety of the relevant social media posts and how they apply in different situations. This challenge of modern research tools manifests itself within the produced results.

For other tools, instead of receiving a query, a document is received from the user. Such tools process the uploaded document to extract the main subjects, and then perform a search for these subjects and returns the results. These tools can be treated as a two-step analytical engine: in the first step, the research tool extracts the main subjects of a document with methods such as word frequency, etc.; and in the second step, the research tool performs a regular search for these subjects over the world of associated social media posts. Such research tools suffer from the same problem of overfitting, sensitivity to the details, and lack of a universal measure for assessing relevance in relation to a user's query.

The results of such research tools are sensitive to the query. That is, tweaking the query in a small direction causes the results to change dramatically. The altered query may exist in a different set of case files, and therefore the results are going to be confusingly different. Moreover, since the focus of these research tools is on one document at a time, the struggle is really to combine and sort the results in terms of relevance to the query. Sorting the results is done based on how many common words exist between the query and the case file, or how similar the language of the query is to that of a case. As a result, the results run the risk of being too dependent on the details of the query and the case file, rather than concentrating on the importance of a case and its conceptual relevance to the query.

Power consumption and carbon footprints are other considerations in research systems, and thus should also be addressed. Analytic systems such as the present invention process big data. For example, when a user enters a query to a system, the system takes the query, and searches data that can be composed of tens of millions of files and websites (if not more), to find matches. This single search by itself requires a lot of resources in terms of memory to store the files, compute power to perform the search on a document, and communication to transfer the documents from a hard disk or a memory to the processor for processing. Even for a single search, a regular desktop computer may not perform the task in a timely manner, and therefore a high-performance server is required. Techniques such as database indexing make searching a database faster and more efficient; however, the process of indexing and retrieving information remain a complex, laborious and time-consuming process. As a result, a legal research tool needs a large data center to operate. Such data centers are expensive to purchase, setup, and maintain; they consume a lot of electricity to operate and to cool down; and they have large carbon footprint. It is estimated that data centers consume about 2% of electricity worldwide and that number could rise to 8% by 2030, and much of that electricity is produced from non-renewable sources, contributing to carbon emissions. A research tool can be hosted on a local data center owned by the provider of the research tool, or it can be hosted on the cloud. Either way, the equipment cost, operation cost, and electricity bill will be paid by the provider of the service one way or another. A more efficient social media analysis tool that only needs a small amount of resources, consumes less electricity per query, and has a smaller carbon footprint compared to existing tools such as those discussed above.

Since social media posts are created by individuals on individual social media platforms, posts need to be scanned to determine if they are possibly harmful or not. Post data across multiple platforms is collected and analyzed to determine if a post could be harmful to the client. So, the invention integrates with the social media platforms and pulls posts from the client's timelines, analyzes the posts and notifies the client of possible harmful posts.

Others do not allow for integration over multiple platforms and require permission and consent from the client to access the data on the post timelines.

Moreover, the impact of a social media post by a user today is currently very subjective without any existing regulation and/or guidance. Prior to this invention, impact has been attempted on a ‘platform-by-platform’ basis. Any cross-platform impact has been done is a subjective fashion, manually.

In fact, most prior art systems are manual and subjective to the reviewer. Those the prior art systems that implement artificial intelligence/machine learning do not analyze as efficiently for each social media post for how impactful the post is within the social media platform based on how many other users view the post and interact with the post. Prior art systems also do not analyze the post across multiple social media platforms to determine the cross-platform reach of the post. Prior art systems do not factor in the personal profile of the account owner (user).

### BRIEF SUMMARY OF THE INVENTION

The disclosed embodiments provide a system for collecting and analyzing data on individual social media for the purpose of detecting harmful posts. The system relies on application programmable interfaces to fetch user posts and local servers to perform profanity, and toxicity checks on aforementioned user posts, and scrubbing those posts from the Internet.

In certain embodiments, the software of the present invention will receive data associated with a user's social media, analyze the social media using a machine learning algorithm, the social media data of the user to identify harmful content based on a measure of profanity and a measure of toxicity, store the social media as harmful or non-harmful content associated with the user's profile, and output a summary of the harmful posts to the user through a graphical user interface, where the user is prompted to delete harmful posts.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram of an exemplary embodiment of the hardware of the system of the present invention;

FIG. 2 is a diagram of an exemplary artificial intelligence algorithm as incorporated into the hardware of the system of the present invention;

FIG. 3 is a diagram showing the user consent flow in accordance with an exemplary embodiment of the invention;

FIG. 4 is a diagram of the analysis scanning (data collection) analysis and reporting/notification flow of the system of the present invention;

FIG. 5 is a diagram of a continuous flow scan in accordance with an exemplary embodiment of the invention;

FIG. 6 is a diagram of an interface for revoking user access and consent revocation subsystem flow in accordance with an exemplary embodiment of the invention;

FIG. 7 is a diagram of an exemplary software process for scanning user social media posts across multiple platforms;

FIG. 8 is a diagram of an exemplary software process for scanning for harmful social media posts; and

FIG. 9 is an exemplary diagram of a screen showing identified harmful social media posts and their classification prior to scrubbing.

### DETAILED DESCRIPTION OF THE INVENTION

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Several preferred embodiments of the invention are described for illustrative purposes, it being understood that the invention may be embodied in other forms not specifically shown in the drawings.

Since social media posts are created by individuals on individual social media platforms, posts need to be scanned to determine if they are possibly harmful or not. Post data across multiple platforms is collected and analyzed to determine if a post could be harmful to the client. So, the invention integrates with the social media platforms and pulls posts from the client's timelines, analyzes the posts and notifies the client of possible harmful posts.

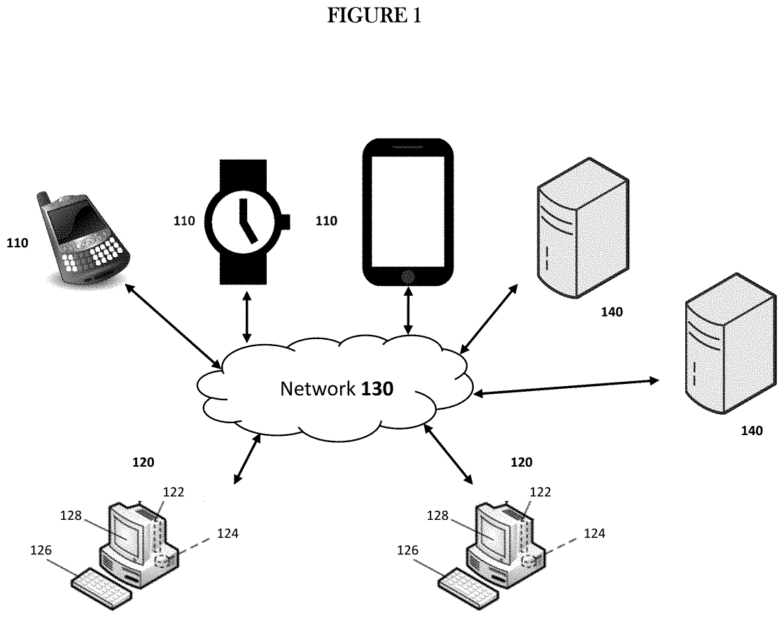

FIG. 1 is an exemplary embodiment of the social media analysis system of the present invention. In the exemplary system 100, one or more peripheral devices 110 are connected to one or more computers 120 through a network 130. Examples of peripheral devices/locations 110 include smartphones, tablets, wearables devices, and any other electronic devices that collect and transmit data over a network that are known in the art. The network 130 may be a wide-area network, like the Internet, or a local area network, like an intranet. Because of the network 130, the physical location of the peripheral devices 110 and the computers 120 has no effect on the functionality of the hardware and software of the invention. Both implementations are described herein, and unless specified, it is contemplated that the peripheral devices 110 and the computers 120 may be in the same or in different physical locations. Communication between the hardware of the system may be accomplished in numerous known ways, for example using network connectivity components such as a modem or Ethernet adapter. The peripheral devices/locations 110 and the computers 120 will both include or be attached to communication equipment. Communications are contemplated as occurring through industry-standard protocols such as HTTP or HTTPS.

Each computer 120 is comprised of a central processing unit 122, a storage medium 124, a user-input device 126, and a display 128. Examples of computers that may be used are: commercially available personal computers, open source computing devices (e.g. Raspberry Pi), commercially available servers, and commercially available portable device (e.g. smartphones, smartwatches, tablets). In one embodiment, each of the peripheral devices 110 and each of the computers 120 of the system may have software related to the system installed on it. In such an embodiment, system data may be stored locally on the networked computers 120 or alternately, on one or more remote servers 140 that are accessible to any of the peripheral devices 110 or the networked computers 120 through a network 130. In alternate embodiments, the software runs as an application on the peripheral devices 110, and include web-based software and iOS-based and Android-based mobile applications.

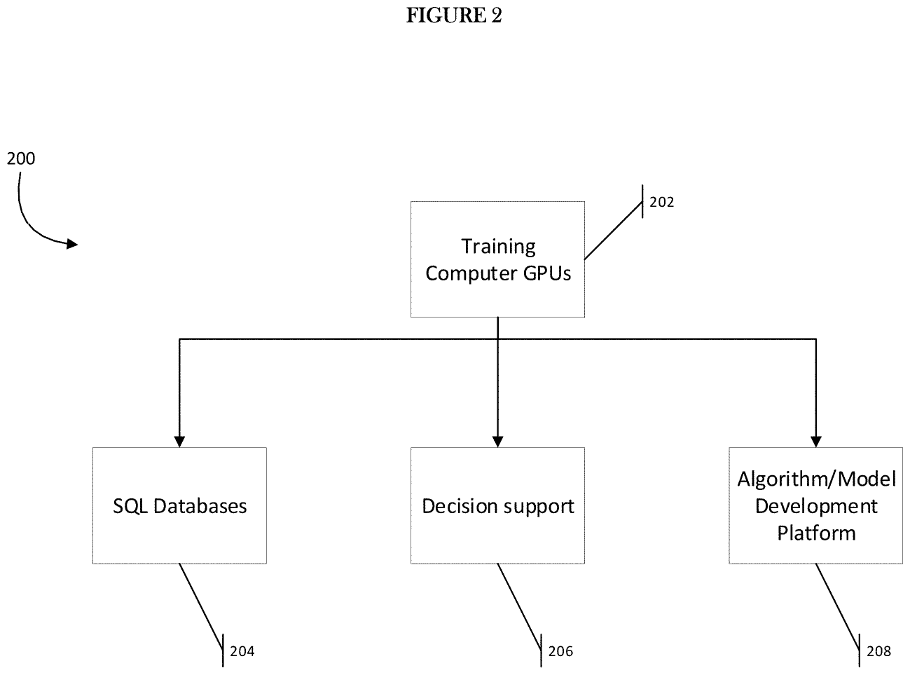

FIG. 2 describes an exemplary artificial intelligence algorithm as incorporated into the hardware of the system of the present invention. To enable the system to operate, a separate training and testing computer or computers 202 with appropriate and sufficient processing units/cores, such as graphical processing units (GPU), are used in conjunction with a database of knowledge, exemplarily an SQL database 204 (for example, comprising terms of interest in social media and their associated semantic/linguistic meanings and effect on a person's reputation), a decision support matrix 206 (for example, cross-referencing possible algorithmic decisions, system states, and third-party guidelines), and an algorithm (model) development module 208 (for example, a platform of available machine learning algorithms for testing with data sets to identify which produces a model with accurate decisions for a particular instrument, device, or subsystem). The learning algorithms of the present invention use a known dataset to thereafter make predictions. The dataset training includes input data that produces response values. The learning algorithms are then used to build predictive models for new responses to new data. The larger the training datasets, the better will be the prediction models. The algorithms contemplated include support vector machines (SVM), neural networks, Naïve Bayes classifier and decision trees. The learning algorithms of the present invention may also incorporate regression algorithms include linear regression, nonlinear regression, generalized linear models, decision trees, and neural networks. The invention comprises of different model architectures such as convolutional neural networks, tuned for specific content types such as image, text and emojis, and video, as well as text-in-image, text-in-video, audio transcription and relational context of multimedia posts.

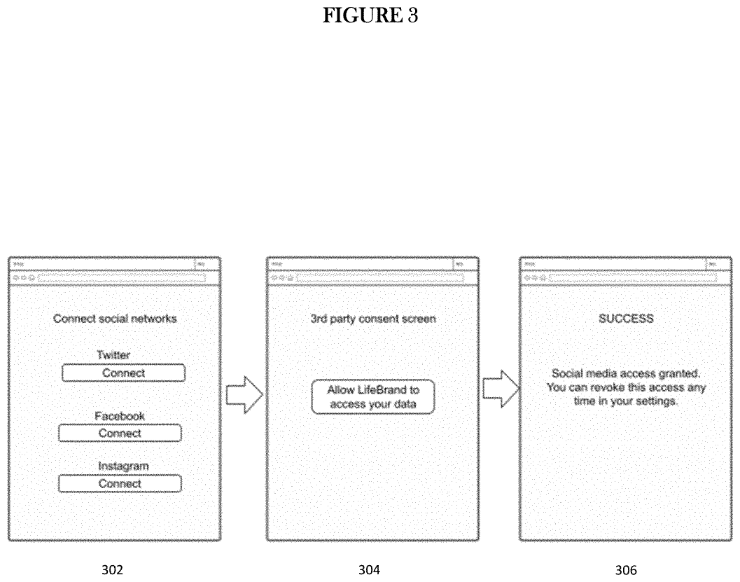

FIG. 3 is a diagram showing the user consent flow in accordance with an exemplary embodiment of the invention. FIG. 3 therefore describes an exemplary protocol for the system of the present invention to obtain authorization from a user prior to performing any analysis of the user's social media. Before any data is collected or analyzed, the user is asked to consent to data collection. Without user consent, no data is stored, nor analyzed. At a first screen 302, a user is prompted to connect his or her social networks to the social media analysis system. The user can connect such social media as Twitter, Facebook, and Instagram to the system. Other social media networks known in the art are also contemplated as being within the scope. Upon approving the connection to a social media network, the user is taken to a third-party consent screen 304. At this screen, the user is asked to verify and affirmatively grant access to his or her social media data to the system of the present invention. Upon granting access to that social media network and its data, the user is returned to a success screen 306, where the system notifies the user that access to his or her social media data has been granted.

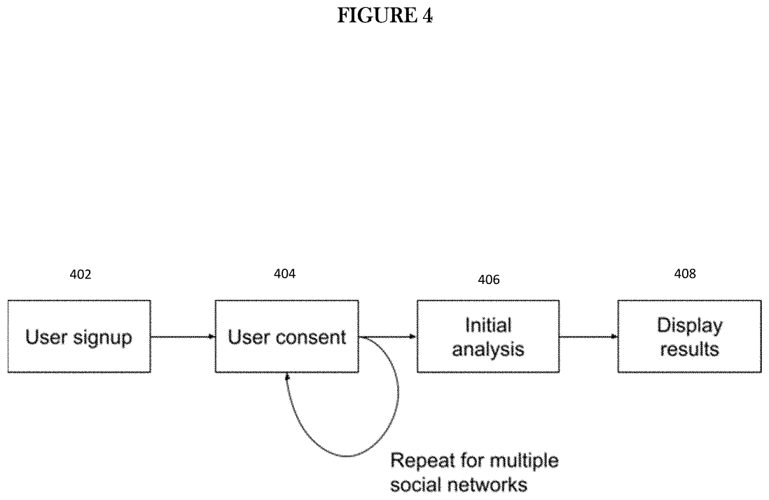

FIG. 4 is a diagram of the analysis scanning (data collection) analysis and reporting/notification flow of the system of the present invention. The process commences at User signup 402, where the user is prompted to sign up for the services provided by the system of the present invention. The system next attempts to obtain user consent 404 for data, as explained with regard to FIG. 3 above. User consent 404 is obtained for one or more social networks, and the steps of FIG. 3 are repeated as necessary for multiple social networks. Once the user's data is collected by the system, an initial analysis is performed to identify unfavorable social media posts or other objectionable data. Unfavorable and objectionable data is identified using a machine learning algorithm, as exemplarily described with respect to FIG. 2 above. Once the user's social media has been analyzed for unfavorable or objectionable data, the results of the analysis are displayed 408.

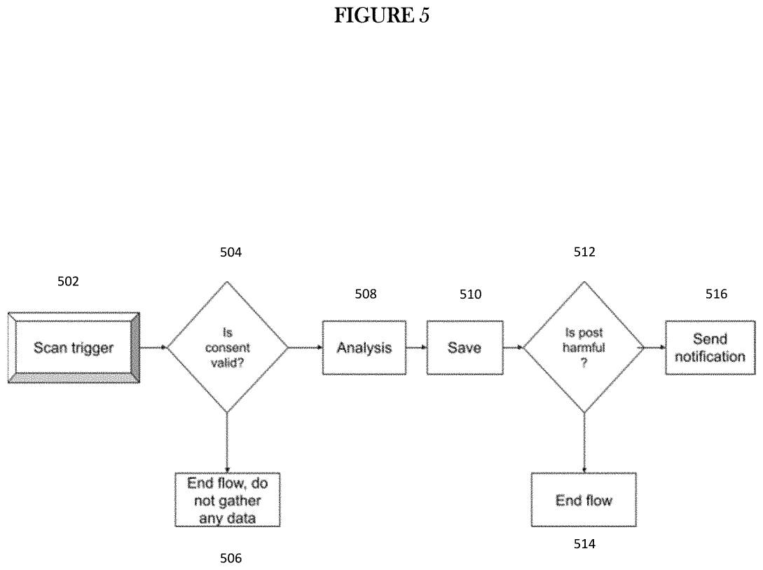

FIG. 5 is a diagram of a continuous flow scan in accordance with an exemplary embodiment of the invention. In certain cases, the system may also perform a continuous scan of the user's social media. The process commences at the scan trigger 502, which can be any predetermined reason to begin a scan of the user's social media. A continuous scan can be triggered by time, detection of an individual post, or change in the analysis algorithm. Regardless of the origin of the scan, the validity of the consent is always checked 504. If consent is determined to not have been granted by the user, the process ends 506, and the system does not collect or analyze any data for the user. If the user has granted the system access to his or her social media data, then the system performs an analysis of the user's social media 508, applying the machine learning algorithms described with regard to FIG. 2 to identify unfavorable or objectionable data. Words, phrases, images, videos, text and audio from image and video are all taken from user social media to perform the analysis. The determinations of the algorithm are saved to the user's profile 510. Those determinations include whether the user post is potentially harmful, and also what category of harmful post it falls under. The system then determines based on the analysis, whether the social media post is harmful 512. If the system determines that there are no harmful posts presents, the system process ends 514. However, if the system determines that there is a harmful post present, it notifies the user 516 so that the user may remove it.

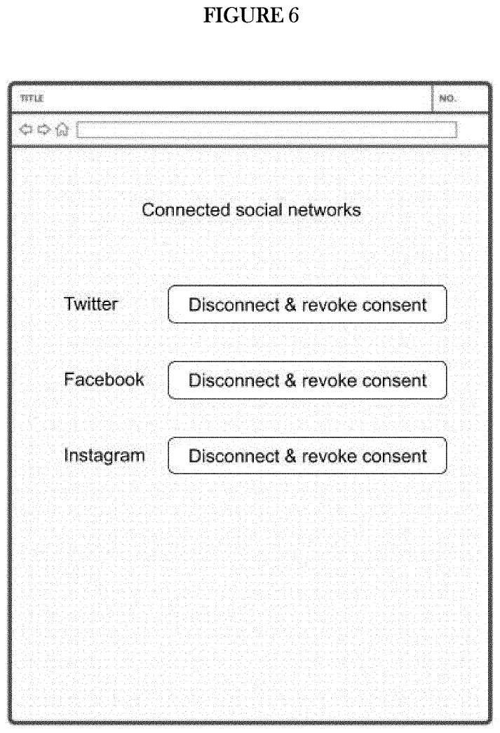

FIG. 6 is a diagram of an interface for revoking user access and consent revocation subsystem flow in accordance with an exemplary embodiment of the invention. Users are presented with an option to revoke granted permissions to individual third-party social networks. The networks include Twitter, Facebook, Instagram, as well as any other social networks known in the art. Other social media platforms can be added as it makes sense to do so. After revoking permission, all the data connected to the user is anonymized and the data is no longer used to analyze users' data.

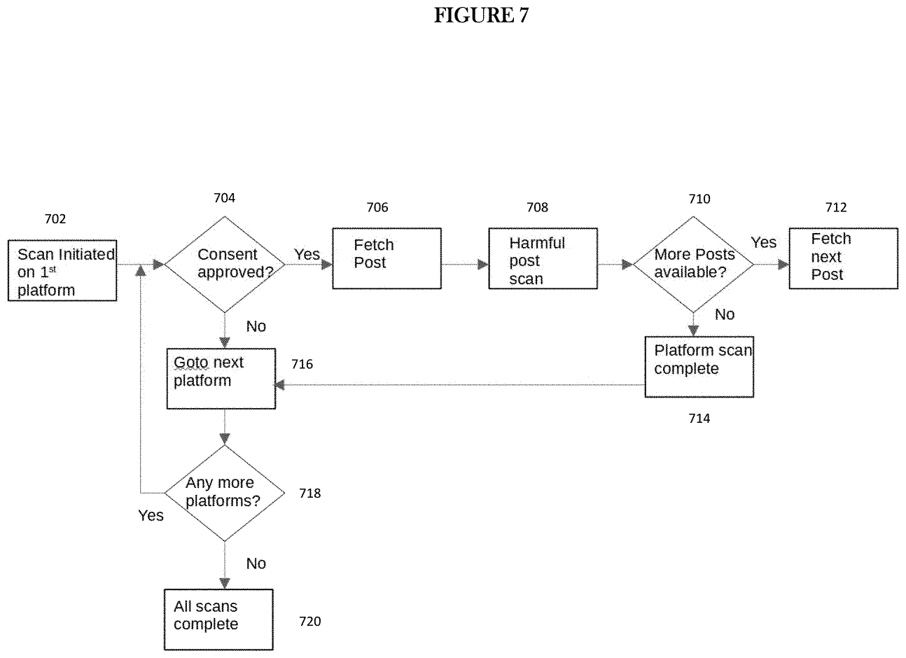

FIG. 7 is a diagram of an exemplary software process for scanning user social media posts across multiple platforms. The process commences with the first scan 702 on a first social media platform. In certain embodiments, the scan comprises requesting the user's login credentials on the social media platform and using an API to request the download of data from the platform. In alternate embodiments, the software may login to the social media platform as the user using his or her credentials and collect the user's social media data in that manner. In other embodiments, the user's credentials may be provided to a preauthorized third party, which is permitted to review the user's social media data using the software.

The software then determines whether the user's consent was received 704 to scan the first social media platform. The process for receiving and verifying consent is as described above.

If consent is verified, then the software fetches a first social media post 706 from the first social media platform and performs a scan to determine whether the post is harmful 708 using the artificial intelligence/machine learning algorithm described above. The software's algorithm analyzes social media posts both alone and in combination with other posts or social media data associated with the user. Thus, social media posts are analyzed by the software on their own and holistically to identify potentially harmful combinations or trends.

The software then queries the social media platform for additional posts 710. In various embodiments, this process can occur in real-time, monitoring user activity, or can be initiated by the user.

If more social media posts are available, then the software will fetch the next post 712. The software will repeat steps 706 through 712 as long as it keeps finding additional social media posts.

When the software determines that there are no longer any social media posts remaining for analysis on the first social media platform, it signals that the platform scan is complete 714 and proceeds to query the next social media platform 716, if one exists.

If additional social media platforms exist 718, the software will repeat steps 704 through 714 as described with respect to the first social media platform until there are no more social media platforms remaining, at which point, the software signals that all scans are complete 720.

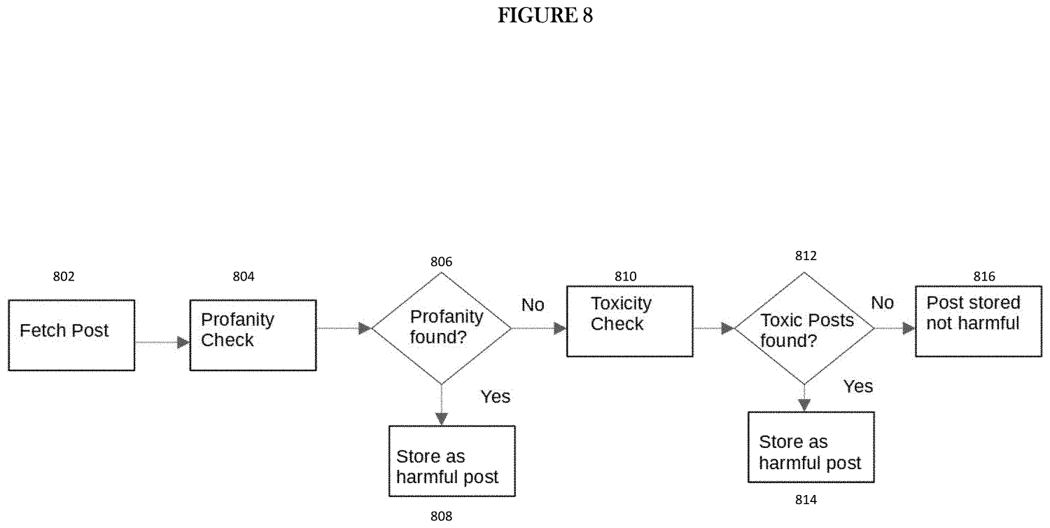

FIG. 8 is a diagram of an exemplary software process for scanning for and identifying harmful social media posts. The process commences when the software fetches a social media post 802. The software performs a profanity check 804 using the artificial intelligence/machine learning algorithm described above. In various embodiments, the profanity check may involve analysis against a list of offensive words and terms as well as natural language processing and context-specific analysis.

If a profanity is found 806, the software stores that social media post 808 in a profile associated with the user that may be stored locally or in the cloud.

If no profanity is found, then the software performs a toxicity check 810 using the artificial intelligence/machine learning algorithm described above.

If a post is identified by the algorithm as toxic 812, then it is stored as a harmful post 814 in a profile associated with the user that may be stored locally or in the cloud.

If the post is not found to be profane or toxic by the algorithm, then it is separately stored as a non-harmful post 816. Posts analyzed by the software may be text, audio, or video. This process is repeated as necessary for all social media posts analyzed with regard to FIG. 7.

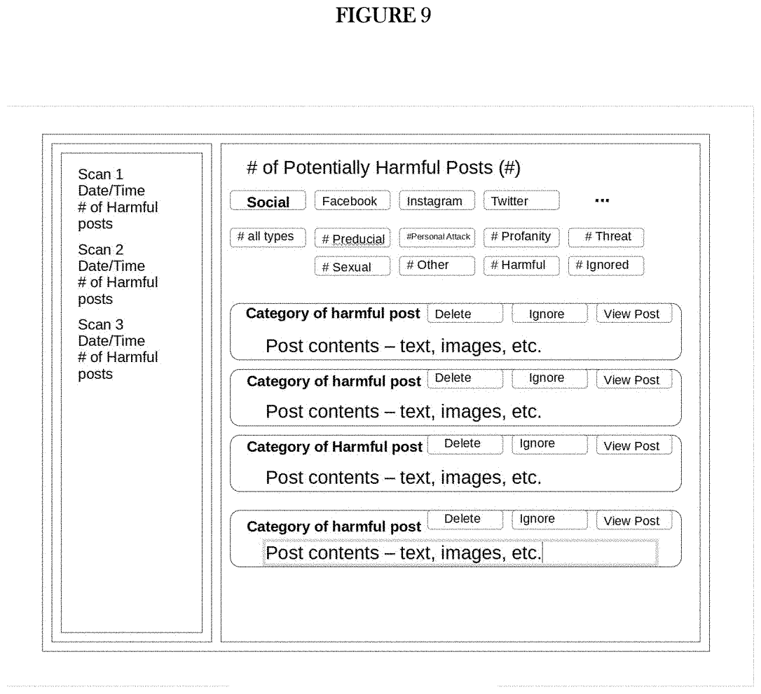

FIG. 9 is an exemplary diagram of a screen showing identified harmful social media posts and their classification prior to scrubbing. Once the software completes its analysis of the user's social media, it presents the user with a screen similar to that shown in FIG. 9. At this screen, the user is shown all of the categorized posts across all social media networks, and harmful posts are highlighted. The user is allowed to view posts, delete posts that the software deems harmful, or ignore posts that the user believes should remain. The artificial intelligence/machine learning algorithm described above is trained based on user responses to more accurately identify harmful posts in future iterations of the analysis.

It should be noted that the foregoing process may be performed on an ongoing basis and repeated as necessary, to provide the user with a current, updated score of his or her social media activity.

The foregoing description and drawings should be considered as illustrative only of the principles of the invention. The invention is not intended to be limited by the preferred embodiment and may be implemented in a variety of ways that will be clear to one of ordinary skill in the art. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A computer-implemented method comprising:
receiving data associated with a user's social media;
analyzing the social media using a machine learning algorithm, the social media data of the user to identify harmful content based on a measure of profanity and a measure of toxicity;
storing the social media as harmful or non-harmful content associated with the user's profile;
outputting a summary of the harmful posts to the user through a graphical user interface, wherein the user is prompted to delete harmful posts.

2. The method of claim 1, wherein the social media comprises the user's posts.

3. The method of claim 1, wherein the data is received from a plurality of social media networks.

4. The method of claim 1, wherein the machine learning algorithm is trained based on the user's responses to the prompts to delete harmful posts.

5. The method of claim 1, wherein the social media is comprised of text, images, or video.

6. The method of claim 1, wherein the user is prompted to view the harmful posts.

7. The method of claim 1, wherein the user is given the option to ignore the harmful posts.

8. The method of claim 1, wherein the machine learning algorithm is comprised of support vector machines (SVM), neural networks, Naïve Bayes classifier, and decision trees

9. The method of claim 1, further comprising storing the harmful posts to a user profile.

10. The method of claim 1, further comprising verifying the user's permission to collect data from the social media.

11. A computer-readable storage medium having computer-executable instructions stored thereupon which, when executed by one or more processors of a computing device, cause the one or more processors of the computing device to:
receive data associated with a user's social media;
analyze the social media using a machine learning algorithm, the social media data of the user to identify harmful content based on a measure of profanity and a measure of toxicity;
store the social media as harmful or non-harmful content associated with the user's profile;
output a summary of the harmful posts to the user through a graphical user interface, wherein the user is prompted to delete harmful posts.

12. The computer-readable storage medium of claim 11, wherein the social media comprises the user's posts.

13. The computer-readable storage medium of claim 11, wherein the data is received from a plurality of social media networks.

14. The computer-readable storage medium of claim 11, wherein the machine learning algorithm is trained based on the user's responses to the prompts to delete harmful posts.

15. The computer-readable storage medium of claim 11, wherein the social media is comprised of text, images, or video.

16. The computer-readable storage medium of claim 11, wherein the user is prompted to view the harmful posts.

17. The computer-readable storage medium of claim 11, wherein the user is given the option to ignore the harmful posts.

18. The computer-readable storage medium of claim 11, wherein the machine learning algorithm is comprised of support vector machines (SVM), neural networks, Naïve Bayes classifier, and decision trees

19. The computer-readable storage medium of claim 11, wherein the one or more processors store the harmful posts to a user profile.

20. The computer-readable storage medium of claim 11, wherein the one or more processors verify the user's permission to collect data from the social media.
